(19) United States
(12) Patent Application Publication
(10) Pub. No.: US 2013/0279058 A1
(43) Pub. Date: Oct. 24, 2013

(54) ELECTRIC FUSE APPARATUS FOR POWER CONTROL CIRCUITS

(71) Applicant: Rainer J. Seidel, Tussenhausen (DE)

(72) Inventor: Rainer J. Seidel, Tussenhausen (DE)

(73) Assignee: HAMILTON SUNDSTRAND CORPORATION, Windsor Locks, CT (US)

(21) Appl. No.: 13/536,129

(22) Filed: Jun. 28, 2012

(30) Foreign Application Priority Data
Apr. 24, 2012 (EP) 12165362.0

(51) Int. Cl. H02H 5/04; H01H 37/02

(52) U.S. Cl. 361/104; 337/401

(57) ABSTRACT

An electrical fuse apparatus comprises a conductor element defining an electrically conductive path between respective wire terminals for connecting the fuse apparatus to an electrical circuit. The conductor element includes a first reactive material and at least one ignition point for receiving external energy to initiate an exothermic reaction of the first reactive material with a second reactive material. The reaction generates a quantity of heat sufficient to melt the conductor and break the conductive path. The fuse can be an element in electrical circuits, including power controllers. A method for protecting a system using an exothermic fuse apparatus is also disclosed.

### BACKGROUND

The application relates generally to electrical systems and more specifically to fuse elements for protecting such systems.

The main operating principle of a conventional electrical fuse is a conductor configured to melt from thermal resistance when the current reaches a critical point, breaking the circuit. Conventional fuses, particularly for large capacity circuits, have correspondingly high electrical resistance, which causes substantial and continuous parasitic losses during normal operation. In addition, operation and resistance of conventional fuses are subject to ambient temperature variation. Since resistance varies with temperature, the conductor is designed or selected to operate so that the fuse does not open prematurely, while also being sufficiently responsive to an over-current condition over the same temperature range. This further inhibits efficiency of the circuit. In addition, conventional resistance based fuses are only responsive to electrical over-current faults in the particular branch of the circuit. They do not respond directly to other faults or conditions in the circuit, or elsewhere in the system that would call for protectively isolating the load from the power source.

### SUMMARY

An electrical fuse apparatus comprises a first fuse end, a second fuse end, and a conductor element. The first and second fuse ends each have at least one respective wire terminal for connecting the fuse apparatus to an electrical circuit. The conductor element defines an electrically conductive path between the respective wire terminals. The conductor element includes a first reactive material and at least one ignition point for receiving external energy to initiate an exothermic reaction of the first reactive material with a second reactive material. The reaction generates a quantity of heat sufficient to melt the conductor and break the conductive path.

An electrical circuit comprises an electrical load, a power source, a power control element configured to manage delivery of power from the power source to the electrical load, and a fuse apparatus. The fuse apparatus includes a conductor element having at least one material configured to undergo an exothermic chemical reaction in response to an identified fault condition. The reaction generates a quantity of heat sufficient to melt the conductor element and isolate the first electrical load from the power source.

A method for protecting elements of a system comprising a first electrical circuit segment is disclosed. The method comprises identifying a fault condition in the system; and triggering an exothermic chemical reaction in an exothermally reactive conductor element to isolate at least one electrically driven component from a corresponding electrical power source.

### BRIEF DESCRIPTION OF THE DRAWINGS

FIG. 1A is a high level block schematic of a power controller in an aircraft control and communication system.

FIG. 1B is an electrical block diagram of an individual branch circuit of the power controller having a solid state switch and an exothermic fuse apparatus.

FIG. 1C is an electrical diagram of the power controller branch circuit shown in FIG. 1B with the fuse apparatus having been activated in response to a fault condition.

FIG. 2A schematically depicts an example of an exothermic fuse apparatus.

FIG. 2B schematically depicts the exothermic fuse apparatus of FIG. 2A having been activated.

FIG. 3A is a perspective view of an example exothermic fuse conductor.

FIG. 3B is a perspective view of an activated example exothermic fuse conductor.

FIG. 4A is a cross-section of the exothermic fuse conductor shown in FIG. 3A.

FIG. 4B is a cross-section of the exothermic fuse conductor shown in FIG. 3A after activation.

FIG. 5A is a high level block schematic of an alternative operational mode of the power controller from FIG. 1A.

FIG. 5B is an electrical block diagram of an alternative operational mode of the individual branch circuit of the power controller from FIG. 1B.

### DETAILED DESCRIPTION

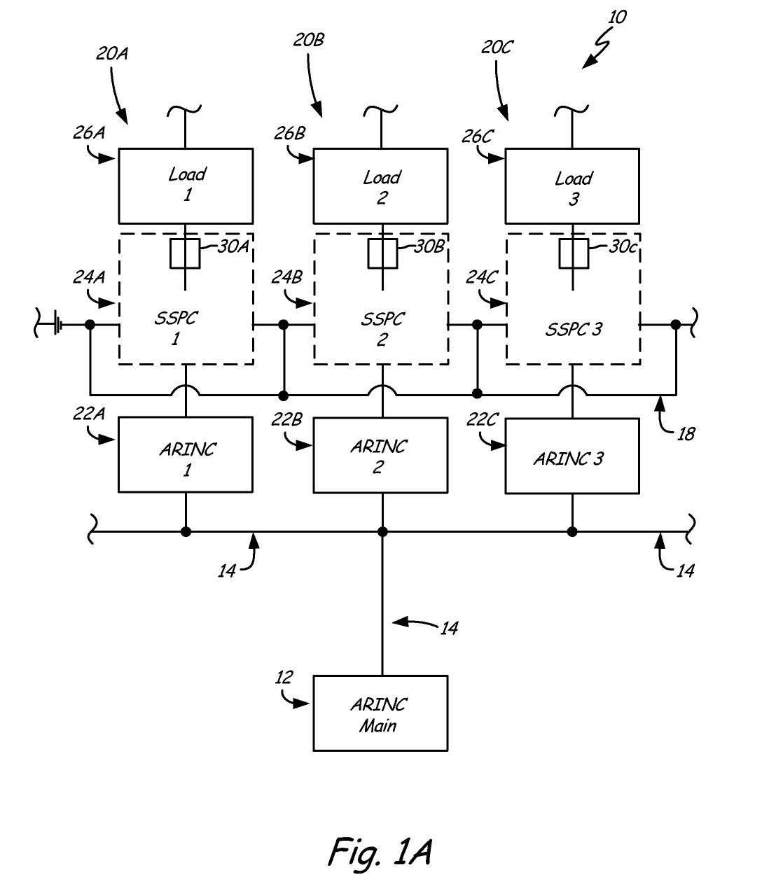

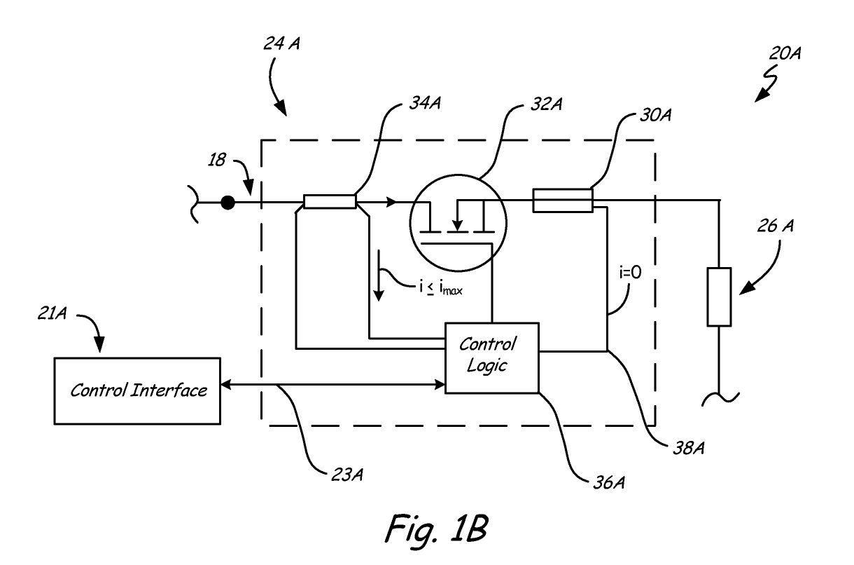

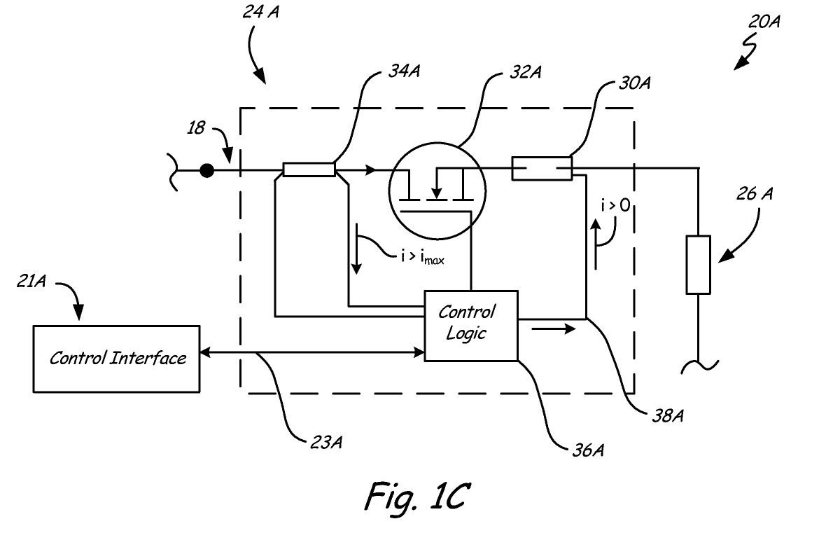

FIG. 1A shows power control system 10, central controller 12, control and communication lines 14, power bus 18, subcircuits 20A, 20B, 20C, subcircuit controllers 22A, 22B, 22C, solid state switches 24A, 24B, 24C, electrical loads 26A, 26B, 26C, and exothermic fuse apparatus 30A, 30B, 30C.

FIG. 1A is a high level block diagram of example power control elements and their relationship to a larger avionic monitoring and control system. While shown as part of an overall control system, the examples can be incorporated into standalone power controller modules as well. More generally, it will be readily apparent that these examples can be readily adapted to a wide variety of electrical applications, including commercial and industrial, as well as complex residential power management applications.

Example monitoring and control system 10 includes central controller 12 to communicate and control various aircraft systems, equipment, sensors and the like. Central controller 12 includes control and communication branch lines 14. Power bus 18 provides power to equipment located in a plurality of system subcircuits 20A, 20B, 20C. While three subcircuits are explicitly shown, it will be recognized that a larger or smaller number of circuits may be provided depending on the system requirements.

Main controller 12 communicates with subcircuit controllers 22A, 22B, 22C via main line 14 and branch lines 16. These controllers and lines are selected to be suitable for a particular application; here, the flight management system operates according to ARINC (Aeronautical Radio, Inc.) standards. Power bus 18 is shown in this illustrative example as providing direct current to subcircuits 20A, 20B, 20C arranged in parallel. More modern aircraft such as next generation more electric aircraft (MEA) utilize alternating current with more complex circuitry dedicated to each subcircuit branch. This may be done for example through a low voltage branch bus (not shown). Other aviation requirements such as failsafe redundancy will also indicate more complex circuitry. But as made clear by the description and figures, the disclosure is applicable to protecting a variety of electrical circuits and not limited to any particular arrangement.

Each subcircuit controller 22A, 22B, 22C communicates with main controller 12, along with sensors, electronics, switches, and other equipment on respective subcircuits 20A, 20B, 20C. This includes control of respective solid state power controller (SSPC) switches 24A, 24B, 24C, which direct power from a source via power bus 18 to operate respective loads 26A, 26B, 26C. Loads 26A, 26B, 26C, may represent any individual or combination of components forming a coherent subsystem. Exothermic fuse apparatus 30A, 30B, 30C, shown as part of respective SSPC switches 24A, 24B, 24C protect loads 26A, 26B, 26C by isolating the respective loads from the power source in response to identification of a relevant fault either in or remote to the respective subcircuit. While shown in these examples as part of the power control switch, any or all of fuse apparatus 30A, 30B, 30C may additionally or alternatively be disposed in any suitable location along the respective subcircuit. For example, they may be incorporated into the equipment represented by loads 26A, 26B, 26C. They may also be located in one or more separate fuse/relay boxes. Example constructions and uses of fuse apparatus 30A, 30B, 30C will be explained in more detail below.

FIG. 1B shows power bus 18, subcircuit 20A, subcircuit control interface 21A, control communication line 23A, SSPC switch 24A, load 26A, exothermic fuse apparatus 30A, switching element 32A, sensor 34A, SSPC logic 36A, and fuse trigger branch 38A. FIG. 1C shows open subcircuit 20A′ with open exothermic fuse apparatus 30A′.

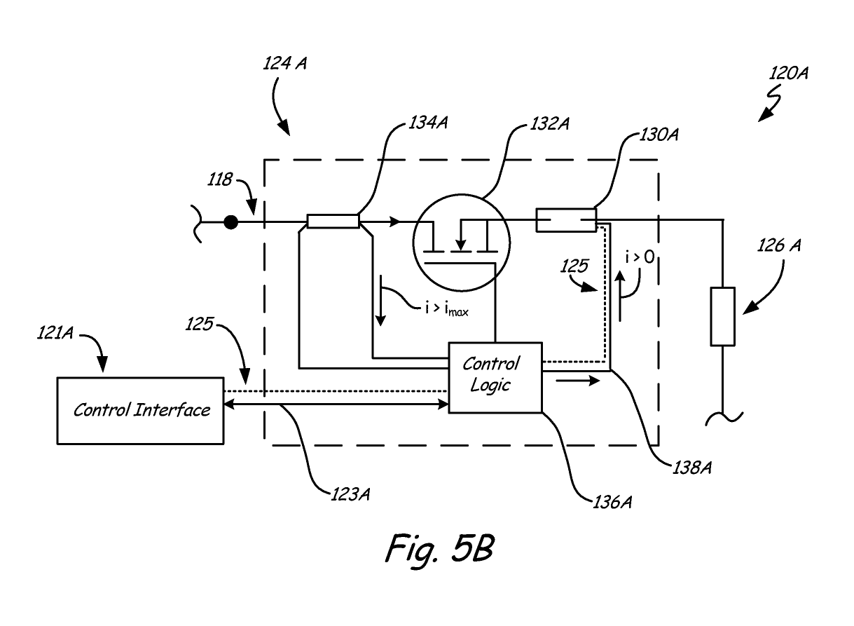

FIGS. 1B and 1C show a traditional protective function utilizing exothermic fuse apparatus 30A with respect to overcurrent faults in circuit 20A. FIG. 1B is a block diagram of subcircuit 20A being protected by exothermic fuse apparatus 30A. FIG. 1C shows open subcircuit 20A′ with open fuse apparatus 30A′ resulting in isolation of load 26A. Exothermic fuse apparatus 30A can also be activated in response to nontraditional fault conditions such as in the example shown in FIGS. 5A and 5B.

As shown in FIGS. 1A-1C, fuse apparatus 30A, 30B, 30C can be respectively disposed in line with loads 26A, 26B, 26C to isolate those loads in the event of a fault identified in the respective subcircuit or outside that subcircuit. Certain components have internal control logic independent of system controllers, and often this often includes self-diagnostic features (e.g. built-in test equipment or BITE systems). These self-diagnostic circuits may detect the fault internally and communicate a signal to a corresponding system or subcircuit controller (e.g., main controller 12 or subcircuit controller 22A). The fault condition can additionally or alternatively be determined indirectly by the system controller(s) via programmable logic in the controller comparing system parameter measurements versus values of those parameters indicative of a normal state.

In this example arrangement, circuit 20A provides current i from bus 18 to drive load 26A, via SSPC 24A. Subcircuit 20A has a critical maximum current iₘₐₓ, which will depend on several factors, most often the maximum rated capacity of the equipment represented by load 26A. The maximum rated capacity can also vary based on the operating environment and particular equipment. In an aircraft, the load will vary based on whether load 26A is for an engine starter, a motor controller, a lubrication pump, or any multitude of electrically operated aircraft components. When load 26A is more robust, the maximum rated load can also be based on other considerations, for example, to limit total current draw into a particular subcircuit, limit current through the system wiring, or to prevent current from reaching critical breakdown voltages of various solid state components, e.g. switching element/MOSFET 32A.

Control signals can be provided to control logic 36A in communication with controllers 12 and/or 22A, shown in FIG. 1A via control interface 21A and line 23A. Control interface 21A can be a standard communication port facilitating two-way communication between system level control units and component level units via the various external communication lines (e.g. lines 14 in FIG. 1A) and the individual communication lines in each component (e.g. communication line 23A).

In this example, the fault condition in subcircuit 20A is i>iₘₐₓ where i is the instantaneous current provided by bus 18 and measured by sensor 34A. Sensor 34A may be a dedicated sensor or a multiplex sensor, but is configured here to at least provide a periodic current signal to an input of switch control logic 36A. When current i is less than the fault condition (i.e., i≦iₘₐₓ), current in fuse trigger branch remains nominally zero as seen in FIG. 1B.

However, when current i exceeds iₘₐₓ, SSPC logic 36A can be configured to send a signal, such as a nonzero current, through trigger branch 38A as shown in FIG. 1C. This signal triggers activation of an exothermic reaction in fuse apparatus 30A, causing it to open into fuse 30A′, isolating load 26A from bus 18. It will be recognized that logic 36A can trigger the nonzero current instantaneously upon the condition being met, or can delay the trigger signal until the condition is met over a given time period. This can be done to prevent power transients from irreversibly opening the circuit.

Exothermic fuse apparatus 30A can also be made responsive to other types of fault conditions identified in subcircuit 20A. Fuse 30A can also be responsive to fault conditions communicated from other subcircuits (e.g., subcircuits 20B, 20C, and main controller 12) to subcircuit 20A. Further, response of fuse 30A to isolate load 26A can also be programmed (via control logic 28A and/or SSPC logic 36A) to be faster, slower, or substantially equivalent to response of a conventional fuse. Fault identification can be made dependent on, or independent of, ambient and system operating conditions such as temperature. And because operation of fuse 30A is not dependent on resistance heating, fuse apparatus 30 also can have lower resistance losses during operation of the circuit as detailed below.

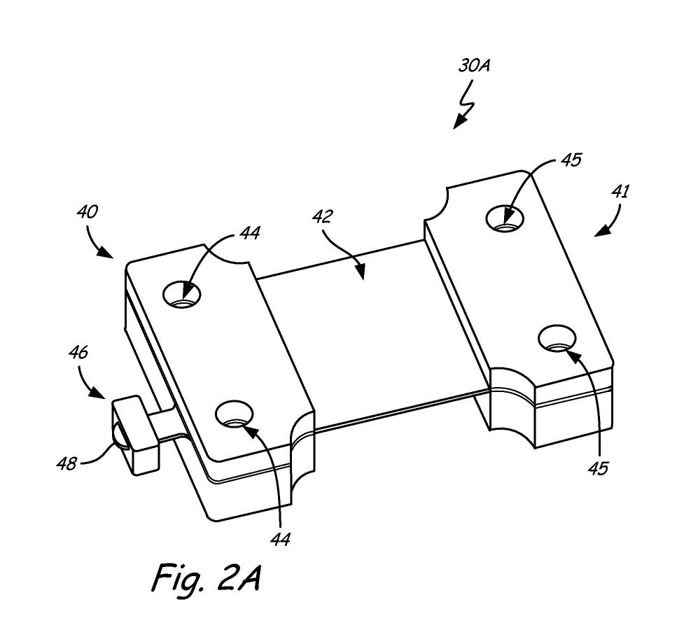

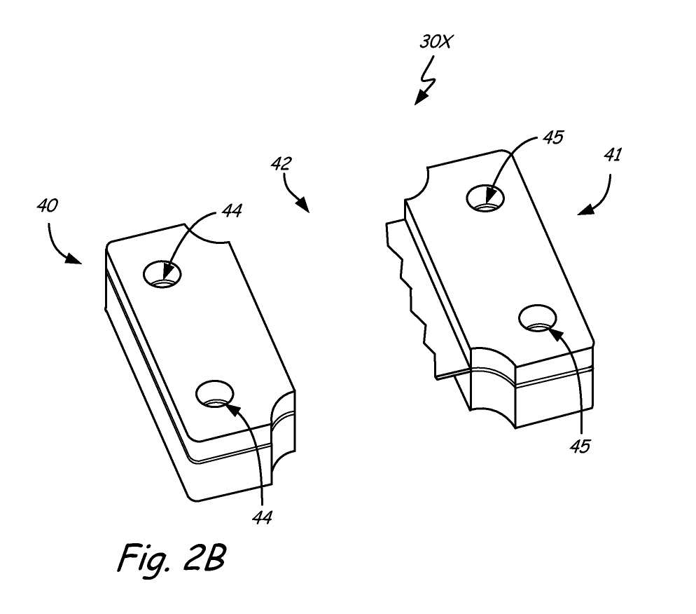

FIG. 2A includes exothermic fuse apparatus 30A, end caps 40, 41, exothermic conductor element 42, wire terminals 44, 45, fuse trigger 46, and fuse pin 48. FIG. 2B shows open exothermic fuse apparatus 30A′ with open conductor element 42′.

FIGS. 2A and 2B respectively show fuse apparatus 30A before activation and open fuse apparatus 30X. Fuse apparatus 30A has end caps 40, 41, each with two respective terminals 44, 45 for securing individual positive and negative/ground leads (not shown) to conduct electrical current through conductor 42. Leads connected to terminals 44, 45 may extend between MOSFET 32A and load 26A as shown in FIGS. 1B and 1C. It will be recognized that other embodiments of fuse apparatus 30A may have more or fewer terminals 44, 45 depending on the particular circuit configuration, Factors include the number of electronic components comprising load 26A as well as arrangements of switching elements, such as SSPC 24A.

As noted above, in this particular example, fuse 30A can be activated upon identification of a fault. One such fault is an overcurrent condition when current i measured at sensor 34A) exceeds iₘₐₓ for a given time (programmed into control logic 28A). Fuse apparatus 30A receives a trigger signal to initiate the exothermic opening reaction.

The exothermic reaction can be initiated by heating or igniting an ignition point on a small portion of conductor 42. In certain embodiments, trigger element 46 can be a small resistive element placed on fuse pin 48. In this example, a plurality of relatively thin windings around pin 48 can serve as trigger 46, with the current generating resistance heating in fuse pin 48. Current in trigger element 46 may directly or indirectly be transmitted from the nonzero current in trigger branch 38A (shown in FIGS. 1B and 1C). When the reaction is initiated at pin 48, conductor 42 reacts exothermally, melting and separating from ends 40, 41 to become open conductor 42′ and breaking continuity between terminals 44, 45.

As with conventional fuses, the elements of exothermic fuse apparatus 30A can have any of a multiplicity of form factors depending on fuse packaging and installation requirements. For this reason and for clarity, any necessary containment structures for debris, melted conductor material, and/or energy effects generated during a conductor reaction event will vary and have thus been omitted from the drawings. However, containment structures are well known with examples including ceramic, glass, plastic, fiberglass, and molded laminates

Conventional fuses are placed in line with components to be protected and thus conduct all of the current (plus switching and transmission losses) required to operate the components during normal operation. The operating principle of a conventional fuse is that the fuse is intentionally designed or selected to have a sacrificial conductor with high electrical resistance. This resistance generates heat in an overcurrent condition sufficient to melt the conductor and open the circuit.

Since its operating principle is based on an exothermic reaction, fuse 30A need not generate an operating resistance equivalent, or even comparable to a conventional fuse, making the overall circuit more efficient. In contrast, conductor 42 does not rely on resistance heating to open the circuit. Thus, conductor 42 can be made from conductive materials such as aluminum, nickel, and magnesium, and alloys thereof. Since they need not generate the same level of resistance, exothermic conductors 42 can be made with smaller form factors giving fuse apparatus 30A a significantly lower resistance than, for example, a copper alloy conductor with more conventional geometry. The lower resistance of fuse 30A improves overall efficiency of the circuit and thus the entire system. Improvements are more pronounced at higher current levels, as conventional fuses will have a larger geometry and much higher parasitic losses.

Exothermic fuse apparatus 30A can replace conventional fuses, or alternatively, it can be used to supplement a conventional fuse. For example, where redundancy takes on greater importance relative to parasitic losses, fuse apparatus 30A can be placed in series to complement a conventional resistance based fuse. Here, the conventional fuse can be configured to protect against overcurrent in the same subcircuit branch, while the exothermic fuse can additionally or alternatively be responsive to other system or circuit faults inside and/or remote to the particular branch subcircuit. This provides redundant overcurrent protection while control logic can be made redundant to protect the circuit from other fault conditions. One example of a fault-responsive circuit arrangement is described with respect to FIGS. 5A and 5B.

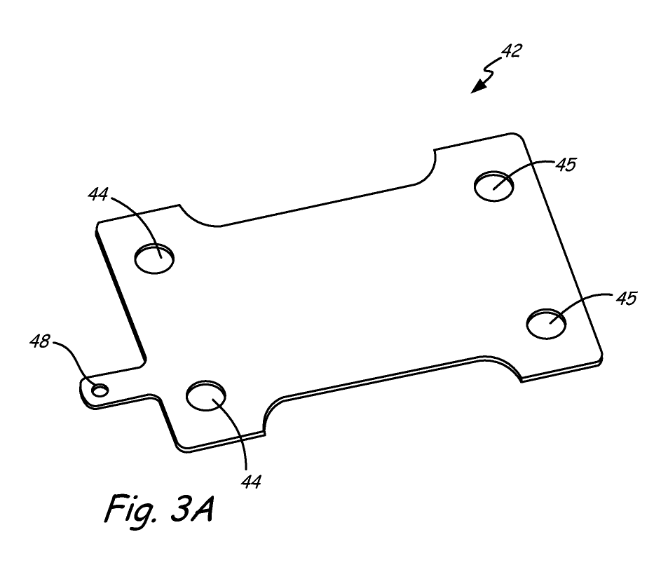

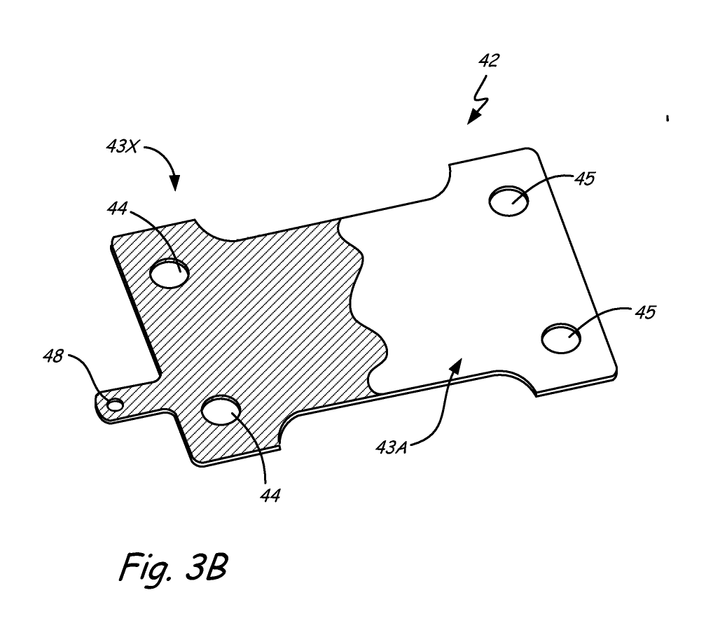

FIG. 3A shows conductor 42 with terminals 44, 45, and pin 48. FIG. 3B also shows conductor 42 with reacted portion 43X and unreacted portion 43A.

FIGS. 3A and 3B show the transition between conductor 42 and 42′. In this particular example, conductor 42 is an agglomeration of a plurality of substantially pure metals. The heat of reaction initiated at fuse pin 48 causes the individual metals to react, forming an alloy and releasing heat which thereby continues the reaction and results in melting conductor 42. Without contact with solid surfaces, conductor 42 tends to disintegrate into melted conductor 42′ and so breaks the electrical continuity between terminals 44, 45. Once ignited, the exothermic reaction continues until all material is transformed or the reaction is stopped. This may be done by containment structures or other protective means (not shown) specific to the exothermic reaction and operating environment. In the example described above, this reaction breaks continuity between switch/MOSFET 32A and load 26A and isolating it from the power source.

Conductor 42 can be fabricated such that activation is no longer necessarily dependent on the ambient temperature, as is the case with conventional fuses. Since resistance of a conventional fuse conductor changes according to ambient conditions, this factor must be taken into account when designing or selecting the fuse. In contrast, activation of fuse 30A (via exothermic conductor 42 is based on control and/or sensor signals as described above. Therefore in the event of fault identification throughout the system, behavior of critical circuits and systems utilizing conductor 42 can be far more predictable.

Conductor 42 can also be designed to compromise between efficiency and inherent secondary protection. For example, in case the signal to trigger element 46 (shown in FIGS. 2A and 2B) fails, or if trigger 46 is otherwise insufficient to initiate the exothermic reaction at pin 48, conductor 42 can nonetheless be designed to have a current carrying limitation at a higher current level than the critical current programmed into SSPC logic 36A. This self-activates the exothermic reaction causing conductor 42 to melt, protecting the circuit and load.

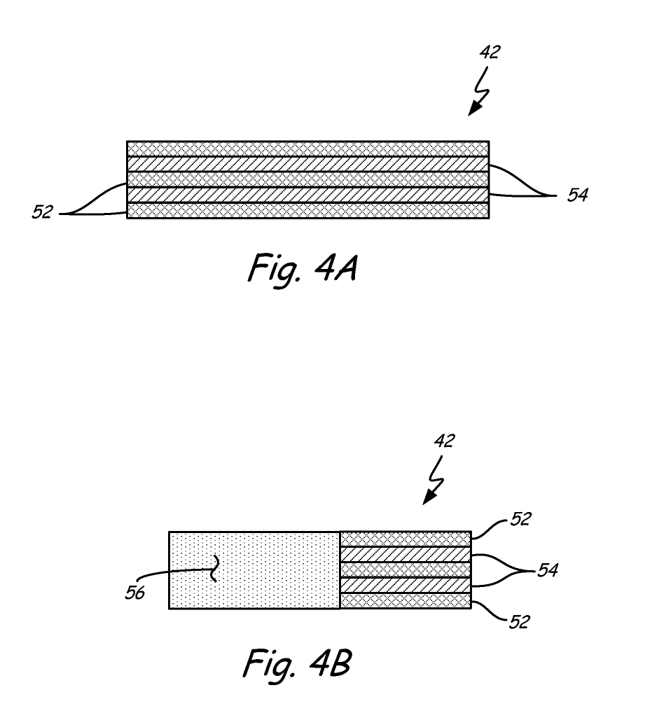

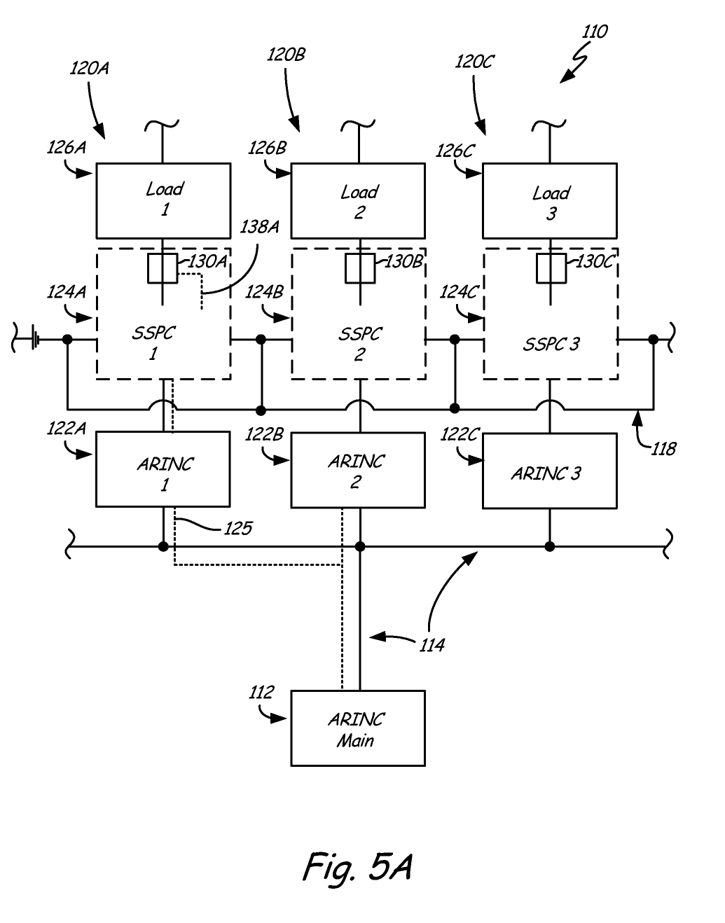

FIG. 4A shows a cross-section of one example conductor 42 with alternating first metal layer 52 and second metal layer 54. FIG. 4B also shows the reaction in progress with alloy 56.

One example of an exothermic reaction for conductor 42 can utilize a plurality of alternating stacked layers of first metal 52 and second metal 54. The sum of the specific energies of those pure metal layers separately is higher than that of an alloy of the metals. Therefore, when triggered, the alternating layers exothermally and almost instantaneously react into an alloy form of the two metals. The heat of reaction results in melting of conductor 42. Without support the melted material falls away, for example onto the fuse packaging (not shown for clarity), thereby breaking the circuit as shown in FIG. 2B.

The layers are extremely thin (e.g. between about 10 nm and about 100 nm thick) and can be produced by various thin film processes. Layer thicknesses between about 40 nm and about 60 nm (averaging about 50 nm) can balance ease of construction with relatively low activation energy. Depending on the metals selected, the layers may be made slightly thicker to minimize inadvertent triggering of the reaction from transient conditions. Specific arrangements will depend on the speed with which the reaction is to occur and the protective requirements around the fuse. In one example, alternating layers include substantially thin film layers of pure aluminum and nickel. A suitable example of this material is available commercially from Indium Corporation of Clinton, N.Y., United States, under the trade designation NanoFoil®.

Other exothermic conductors can be made with metals specifically reactive to air or other gases which may be contained in the fuse packaging or which may be released into the fuse packaging upon activation of trigger 46. For example, exothermic conductor 42 may include a single reactive metal or combination of metals configured to react with the surrounding atmosphere. In these examples, the conductor 42 can include a coating that, upon compromise causes the reactive metal(s) to be in contact with the atmosphere, triggering the reaction. Compromise of the coating may occur based on trigger 46 receiving an appropriate signal via trigger branch 36A to heat or otherwise react the protective coating to expose reactive metal(s).

FIGS. 5A and 5B correspond to FIGS. 1A and 1B, showing an alternative embodiment of the power controller diagrams utilizing fuse apparatus 30A.

FIG. 5A shows an alternative power controller configuration 110 which includes central controller 112, main control and communication line 114, control and communication branch lines 116, main power bus 118, subcircuits 120A, 120B, 120C, subcircuit controllers 122A, 122B, 122C, fault signal path 125, solid state switches 124A, 124B, 124C, electrical loads 126A, 126B, 126C, exothermic fuse apparatus 130A, 130B, 130C, and fuse trigger branch 138A.

FIG. 5B shows main power bus 118, subcircuits 120A, 120B subcircuit controller interface 121A, control signal path 123, SSPC switch 124A, fault signal path 125, load 126A, exothermic fuse apparatus 130X, switching element 132A, sensor 134A, SSPC logic 136A, and fuse trigger branch 138A.

Subcircuit 20A was shown above in FIGS. 1A-1C as implementing exothermic fuse 30A in response to detecting or determining an overcurrent condition in that same subcircuit. In this example, alternative system 110 is shown with an example fault signal path 125 connecting subcircuits 120A, 120B. Fault signal path 125 shows the path of a signal sent by either main controller 112 and/or subcircuit controller 122B upon detection or determination of a relevant fault in subcircuit 120B, or elsewhere in the system. The fault condition is communicated using one or more branches of path 125, via control signal path 123 and trigger branch 138 to open the circuit via activation of the fuse into fuse 130X. The actual problem represented by the fault condition need not be part of the ordinary monitoring of the electrical control system but could additionally be triggered manually or by an external event.

Operation of circuit 110 and fuse apparatus 130 can take a similar tack as to the example described above. Controller 122B and/or main controller 112 communicates a fault signal to first subcircuit controller 122A which produces a trigger signal directing it to open fuse 130A. As here, the trigger signal may originate from the local controller upon receipt of that remote signal or alternatively the remote signal may be transmitted via a direct intercircuit branch. Upon recognition or notification of a relevant fault, control logic 136B induces a nonzero current in trigger line 138B to activate fuse trigger 146 in contact with fuse pin 148. In one example of this effect, an overcurrent condition in subcircuit 120B triggers opening of first fuse 130A as well as fuse 130B.

This may be programmed to occur, for example, because irrevocable loss of load 126B (by activation of fuse 130B due to the overcurrent fault) in certain conditions may negatively impact the first load if it continues to operate. Such conditions can be programmed into local controller 122B and/or main controller 112. In another example, fuse 130A is activated to interrupt electrical power to a fuel pump or to a solenoid valve (serving as load 126A). In this example, a sensor may identify an electrical anomaly in the system potentially representing a short circuit. Depending on the configuration, physically adjacent systems on separate subcircuits may be preemptively shut down by triggering fuse 130A. Thus the fuse can protect systems, even if the sensor and/or the area being monitored is on a separate subcircuit branch. This can also have the effect of simplifying wiring for redundancy and failsafe systems.

While described with reference to aircraft control systems, each physical, chemical, biological effect for which an appropriate sensor/circuit can be defined and for which fuse protection is desirable, a plurality of exothermic fuse apparatus can be used in a comprehensive electrical protection scheme. And as described above, activation of the exothermic fuse apparatus need not necessarily be a result of excessive high electric current in the same subcircuit branch. While fuse 30A may be a replacement for a conventional electric fuse, but with much lower ignition energy, fuse 30A may be provided and activated for any physical, chemical, or biological system with appropriately implemented control logic to issue a trigger signal.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

An electrical fuse apparatus comprises a first fuse end, a second fuse end, and a conductor element. The first and second fuse ends each have at least one respective wire terminal for connecting the fuse apparatus to an electrical circuit. The conductor element defines an electrically conductive path between the respective wire terminals. The conductor element includes a first reactive material and at least one ignition point for receiving external energy to initiate an exothermic reaction of the first reactive material with a second reactive material. The reaction generates a quantity of heat sufficient to melt the conductor and break the conductive path.

The apparatus of the preceding paragraph can optionally include, additionally and/or alternatively, any one or more of the following features, configurations and/or additional components:

a trigger element is integrated with the at least one ignition point;

the trigger element is responsive to a fault signal received from an external controller;

the trigger element is a plurality of electrical windings configured to induce resistive heating in a portion of the fuse element upon a trigger current being flowed through the windings;

the first material comprises a plurality of first thin-film metal layers alternating with a second plurality of thin-film metal layers of the second material, the first and second pluralities of thin-film metal layers configured to form a molten alloy of the first material and the second material upon initiation of the exothermic reaction; and

the first plurality of thin-film metal layers comprise aluminum and the second plurality of thin-film metal layers comprise nickel.

An electrical circuit comprises an electrical load, a power source, a power control element configured to manage delivery of power from the power source to the electrical load, and a fuse apparatus. The fuse apparatus includes a conductor element having at least one material configured to undergo an exothermic chemical reaction in response to an identified fault condition. The reaction generates a quantity of heat sufficient to melt the conductor element and isolate the first electrical load from the power source.

The apparatus of the preceding paragraph can optionally include, additionally and/or alternatively, any one or more of the following features, configurations and/or additional components:

the fault condition is related to a fault condition identified in the first circuit;

the fault condition is related to a fault condition identified outside the first circuit;

the power control element includes a first solid state switch;

a power controller comprises the electrical circuit, and a first circuit segment controller configured to identify and communicate fault conditions in the first circuit segment;

a trigger signal to initiate the reaction in the first exothermic fuse apparatus originates in one of: the first power control element or the first circuit segment controller;

a plurality of interconnected circuit segments each have a respective segment controller; and

each respective circuit segment controller is configured to send and receive fault signals to other of the respective circuit segment controllers.

A method for protecting a system comprising an electrical circuit is disclosed. The method comprises identifying a fault condition in the system; and triggering an exothermic chemical reaction in an exothermally reactive conductor element to isolate at least one electrically driven component from a corresponding electrical power source.

The method of the preceding paragraph can optionally include, additionally and/or alternatively, any one or more of the following features, configurations, steps, and/or additional components:

the first electrical circuit includes a first control element configured to perform the identifying step;

the triggering step is performed by the first control element in response to the first fault condition being identified by the first control element;

the triggering step is performed by a second control element in response to a fault signal received from the first control element after having identified the fault condition;

the triggering step is performed by providing an electrical signal to a plurality of electrical windings wrapped around a portion of the conductor; and

the conductor comprises a plurality of thin metal layers.

1. An electrical fuse apparatus comprising:
a first fuse end;
a second fuse end, the first and second fuse ends each having at least one respective wire terminal for connecting the fuse apparatus to an electrical circuit; and
a conductor element defining an electrically conductive path between the respective wire terminals, the conductor element including a first reactive material and at least one ignition point for receiving external energy to initiate an exothermic reaction of the first reactive material with a second reactive material that generates a quantity of heat sufficient to melt the conductor and break the conductive path.

2. The fuse apparatus of claim 1, wherein a trigger element is integrated with the at least one ignition point.

3. The fuse apparatus of claim 2, wherein the trigger element is responsive to a fault signal received from an external controller.

4. The fuse apparatus of claim 2, wherein the trigger element is a plurality of electrical windings configured to induce resistive heating in a portion of the fuse element upon a trigger current being flowed through the windings.

5. The fuse apparatus of claim 1, wherein the first material comprises a plurality of first thin-film metal layers alternating with a second plurality of thin-film metal layers of the second material, the first and second pluralities of thin-film metal layers configured to form a molten alloy of the first material and the second material upon initiation of the exothermic reaction.

6. The fuse apparatus of claim 5, wherein the first plurality of thin-film metal layers comprise aluminum and the second plurality of thin-film metal layers comprise nickel.

7. An electrical circuit comprising:
a electrical load;
a power source;
a power control element configured to manage delivery of power from the power source to the electrical load; and
a fuse apparatus including a conductor element having at least one material configured to undergo an exothermic chemical reaction in response to an identified fault condition, the reaction generating a quantity of heat sufficient to melt the conductor element and isolate the electrical load from the power source.

8. The circuit of claim 7, wherein the fault condition is related to a fault condition identified in the first circuit.

9. The circuit of claim 7, wherein the fault condition is related to a fault condition identified outside the first circuit.

10. The circuit of claim 7, wherein the power control element includes a first solid state switch.

11. A power controller comprising:
an electrical circuit as recited in claim 7; and
a first circuit segment controller configured to identify and communicate fault conditions in the first circuit segment.

12. The power controller of claim 11, wherein a trigger signal to initiate the reaction in the first exothermic fuse apparatus originates in one of: the first power control element or the first circuit segment controller.

13. The power controller of claim 11, comprising a plurality of interconnected circuit segments each having a respective segment controller.

14. The power controller of claim 13, wherein each respective circuit segment controller is configured to send and receive fault signals to other of the respective circuit segment controllers.

15. A method for protecting a system comprising an electrical circuit, the method comprising:
identifying a fault condition in the system;
triggering an exothermic chemical reaction in an exothermally reactive conductor element to isolate at least one electrically driven component from a corresponding electrical power source.

16. The method of claim 15, wherein the first electrical circuit includes a first control element configured to perform the identifying step.

17. The method of claim 16, wherein the triggering step is performed by the first control element in response to the first fault condition being identified by the first control element.

18. The method of claim 16, wherein the triggering step is performed by a second control element in response to a fault signal received from the first control element after having identified the fault condition.

19. The method of claim 16, wherein the triggering step is performed by providing an electrical signal to a plurality of electrical windings wrapped around a portion of the conductor.

20. The method of claim 16, wherein the conductor comprises a plurality of thin metal layers.
